(19) United States
(12) Patent Application Publication
(10) Pub. No.: US 2023/0062259 A1
(43) Pub. Date: Mar. 2, 2023

(54) FILTER DEVICE FOR A WATER-BEARING DOMESTIC APPLIANCE, WATER-BEARING DOMESTIC APPLIANCE AND METHOD FOR CLEANING THE FILTER DEVICE

(71) Applicant: E.G.O. Elektro-Geraetebau GmbH, Oberderdingen (DE)

(72) Inventors: Antonio Di Maggio, Schwaigern (DE); Uwe Schaumann, Oberderdingen (DE)

(21) Appl. No.: 17/820,016

(22) Filed: Aug. 16, 2022

(30) Foreign Application Priority Data
Aug. 31, 2021 (DE) 10 2021 209 568.2

(51) Int. Cl. B01D 29/96; B01D 29/01; B01D 29/56; B01D 35/30; B01D 29/66; D06F 39/10

(52) U.S. Cl. CPC B01D 29/965; B01D 29/01; B01D 29/56; B01D 35/306; B01D 29/66; D06F 39/10; B01D 2201/282

(57) ABSTRACT

A filter device for a water-bearing domestic appliance has a flow-through filter housing with waste water inlet, filtered water outlet and filtrate outlet, at least one panel filter and a mounting therefor in the filter housing, wherein the panel filter has a mesh width and an angle to the horizontal, and a filtrate chamber in the filter housing for collecting filtrate. The panel filter, the waste water inlet and the filtered water outlet are arranged relative to one another such that a flow direction for water from the waste water inlet to the filtered water outlet passes through the panel filter. The filtrate chamber is accessible via the filtrate outlet for removing the filtrate from the filtrate chamber, in particular by backwashing. The at least one panel filter is variable in shape to change its mesh width, and/or an angle of the at least one panel filter to the horizontal can be altered by movement of the panel filter, in particular rotation.

### CROSS-REFERENCE TO RELATED APPLICATIONS

This application claims priority to German Application No. 10 2021 209 568.2, filed Aug. 31, 2022, the contents of which are hereby incorporated herein in its entirety by reference.

### AREA OF APPLICATION AND PRIOR ART

The invention relates to a filter device for a water-bearing domestic appliance, to such a water-bearing domestic appliance, in particular a washing machine, and to a method for cleaning such a filter device.

A filter device for a water-bearing domestic appliance in the form of a dishwasher is known from DE 102019205919 A1. The filter device there is arranged on the underside of a sump of the dishwasher.

A further filter device for a washing machine is known from DE 102019203809 B3. This filter device can be easily backwashed to clean it.

### OBJECT AND SOLUTION

The object underlying the invention is to create a filter device for a water-bearing domestic appliance, such a water-bearing domestic appliance, and a method for cleaning such a filter device, using which problems of the prior art can be solved and it is in particular possible to use the filter device efficiently during operation of the domestic appliance and to clean it easily.

This object is solved by a filter device having the features of claim 1, by a water-bearing domestic appliance having the features of claim 15 and by a method having the features of claim 17 for cleaning such a filter device. Advantageous and preferred embodiments of the invention are the subject matter of further claims and are explained in greater detail in the following. Some of the features are described only for the filter device, only for the domestic appliance or only for the method. They are however intended to apply by themselves and independently of one another both for the filter device and for the domestic appliance and the method for cleaning them. The wording of the claims is based on express reference to the content of the description.

It is provided that the filter device has a flow-through filter housing with waste water inlet, filtered water outlet and filtrate outlet. It has at least one panel filter and a mounting for the panel filter in the filter housing, wherein the panel filter has a defined/predetermined mesh width and a defined/predetermined angle to the horizontal. It also has a filtrate chamber in the filter housing for collecting filtrate retained by the panel filter.

The panel filter, the waste water inlet and the filtered water outlet are arranged relative to one another such that a flow direction for water from the waste water inlet to the filtered water outlet passes through the panel filter, preferably necessarily through the panel filter. Filtration of the water can thus be assured. The filtrate chamber is accessible via the filtrate outlet for removing the filtrate from the filtrate chamber.

In accordance with the invention, the at least one panel filter is variable in shape to change its mesh width. Alternatively or additionally, the angle of the at least one panel filter to the horizontal can be altered by movement of the panel filter. In this way a filtering degree or the filter properties of the filter device can be changed without replacing one of the panel filters. It is also not necessary to provide any diversion for water flows. The change in the filtering degree or in the filter properties can be used in different ways, advantageously for improved backwashing of the at least one panel filter.

In an embodiment of the invention, the filtrate outlet can lead directly to the filtrate chamber and/or lead directly from the filtrate chamber. Preferably, the filtrate outlet can be closeable and openable by means of a chamber closure on the filter housing, for which in particular a valve is suitable for this chamber closure. If two panel filters are provided in the filter device, in particular a coarse filter and a fine filter, each of them can be provided with its own filtrate chamber and its own filtrate outlet. The two filtrate outlets may then be merged for joint disposal of the filtrate, alternatively they can be separate for separate disposal in each case.

In an advantageous embodiment of the invention, at least one panel filter has a substantially flat shape, with preferably all panel filters having a substantially flat shape. In particular, the at least one panel filter can be designed flat. In this respect, its shape can also be designed changeable, wherein it should preferably retain its substantially flat form but can be for example slightly rotated or slightly wavy.

In a particularly advantageous embodiment of the invention, the filter device can have at least two panel filters, and in particular these panel filters can each have a different filtering degree for filtration. Preferably, the at least two panel filters are arranged one behind the other in the filter housing, in the flow direction of the water through the filter device. This is explained in more detail in the following. It can be provided that these at least two panel filters are arranged one above the other, and that water after being filtered passes first through an upper panel filter and then reaches the lower panel filter. The at least two panel filters can be arranged in planes that may be parallel to one another, but this is not essential. It is possible for a first panel filter to be arranged above a second panel filter. The waste water inlet can advantageously be arranged in front of or above the upper first panel filter in the flow direction. A filtered water outlet is then advantageously arranged behind or below the lower second panel filter in the flow direction, such that water is filtered by both panel filters one after the other, i.e. twice.

It is advantageously provided here that a coarse panel filter is provided for a coarse filtering degree and a fine panel filter for a fine filtering degree. An upper first panel filter preferably forms a coarse filter, in particular for coarse objects of more than 2 mm in diameter. A lower second panel filter preferably forms a fine filter, in particular for impurities or particles greater than 1 μm or greater than 50 μm in diameter. It is possible here to filter out microfibers too, for example.

In a further embodiment of the invention, the at least one panel filter can generally be positioned inclined at an angle of between 0° and 30° to the horizontal, so that water to be filtered that contacts it spreads well over its surface. A downward-facing or downward-inclined outer rim of the panel filter can face the filtrate chamber, in particular be in a vertical line directly above the filtrate chamber. This makes it possible for filtrate to collect not above the panel filter, but instead in a largely separate chamber or separate area. Filtrate can however also be collected above the panel filter or on the panel filter, such that this area forms the filtrate chamber.

A first panel filter, in particular a coarse filter with a coarse filtering degree, can in one possible embodiment be arranged behind or underneath the waste water inlet in the flow direction and be positioned inclined at an angle between 0° and 30° to the horizontal. The flow direction then passes through the first panel filter directly to the filtered water outlet, wherein a lower outer rim of the first panel filter ends above a separate filtrate chamber. A second panel filter, in particular a fine filter with a fine filtering degree, is arranged on this filtrate chamber. It is arranged between the filtrate chamber and the filtered water outlet such that filtered water passing through the second panel filter is filtered with its second filtering degree. It can in particular be aligned or arranged vertically.

A rectangular shape can be provided for the panel filters. This is particularly good for enabling the shape of the panel filter to be influenced in order to affect the filtering degree, as is explained in more detail in the following.

Advantageously, an actuator device designed for changing the shape of the panel filter and hence for affecting its filtering degree is arranged on the panel filter. The actuator device is particularly advantageously designed to bend, rotate or either compress or stretch a panel filter one or more times, i.e. to change it in its length and/or width. The panel filter preferably has pores or filter meshes that can be altered by the shape change, and whose mesh width can be changed, in such a way that impurities sticking to the panel filter are detachable during backwashing of the panel filter against the flow direction of the water. This allows these impurities or coarse objects and/or fine objects to be removed from the filter.

In an embodiment of the invention, the actuator device can be designed bimetallic, as a shape-memory alloy, variable in shape by changing a pH value in its environment, and operating electromotively, electromagnetically or electrothermically. There are thus a large number of different possibilities for influencing the actuator device or for effecting or reversing a shape change of the panel filter. One possibility is direct operation by changing a current flow. Another possibility is an “indirect” operation using water flowing through the filter device and hence affecting above all thermically, possibly also using the pH value of the environment, the shape and hence the filtering degree of the panel filter by means of the actuator device.

In a possible further embodiment of the invention, the panel filter can have an auxetic structure. The aforementioned pores or filter meshes, and hence the filtering degree too, can be altered in their size or mesh width thanks to the auxetic structure.

Advantageously, part of a frame of the panel filter or a mounting for the panel filter can consist of a shape-memory alloy or have an actuator device consisting of a shape-memory alloy. A shape change of the shape-memory alloy is advantageously temperature-dependent, wherein a trigger temperature for the shape change can be between 20° C. and 80° C., in particular between 40° C. and 60° C. Such a temperature range can be easily attained in a normal washing cycle.

In an embodiment of the invention, a heater can be associated with the at least one panel filter or with one of the aforementioned actuator devices. Such a heater can be arranged relatively close, in particular at a distance of less than 2 cm, to the panel filter or to the actuator device in the filter housing. Alternatively, the heater can be an integral part of a filter surface of the panel filter itself, such that wires or filaments, for example, that form the filter or its filter meshes, can be at least partially electrically conductive.

It is possible with the invention to design the filter housing or the at least one panel filter rotatable, preferably by 180°, about a horizontal rotation axis. A rotary drive arranged outside the filter housing can be provided for rotatability. The rotary drive can be designed here such that it operates electromotively, for example as a stepping motor, electromagnetically or electrothermically.

An entire water-bearing domestic appliance in accordance with the invention has a previously described filter device and a treatment chamber for items to be cleaned; water pipes to the treatment chamber and away from the treatment chamber; valves on or in the water pipes; and a fresh water connection from the outside to the domestic appliance plus a drain connection out of the domestic appliance. Furthermore, it has a pump and a heating unit that are interconnected to the water pipes and connected to the treatment chamber and to the filter device. Finally, it has an appliance control unit, advantageously a single appliance control unit that is also responsible for the filter device. The filter device can here be arranged in the flow direction of the water between the treatment chamber and the pump. Preferably, no functional units are arranged between the treatment chamber and the filter device except for filters or strainers and valves. In this way a structure can be simplified for greater practicality.

A method in accordance with the invention has, in addition to a filter operation, a backwashing operation for the filter device to clean an aforementioned filter device. During filter operation, water to be filtered enters or is pumped into the filter device at the waste water inlet, with filtered water exiting at the filtered water outlet and being pumped further by means of the pump in the domestic appliance. During the backwashing operation of the filter device or of at least one of the panel filters of the filter device, the shape and/or the arrangement of the panel filter in the filter housing are changed. As previously described, the filtering degree can be changed thereby, such that a higher filtering degree can be set for backwashing. This can be used so that particles retained in the panel filter can be more easily detached/removed, allowing them to be easily removed during backwashing both clear of the panel filter and out of the entire filter device.

In an advantageous embodiment of the invention, the shape and/or the arrangement of the panel filter in the filter housing can be changed thermically, for which heating is for example ideal, preferably of the panel filter itself or of an actuator device for the panel filter. This can be achieved by a temperature change of the water entering the filter device and reaching the panel filter, whether during filtering or backwashing. Alternatively, a specially controllable electric heating device can be provided for this purpose. Additionally or alternatively to heating, mechanical changes can be made by shaping of the panel filter. Suitable possibilities to do so, in particular actuators too, have already been described above.

In an advantageous embodiment of the invention, the pump can, during backwashing of the at least one panel filter, pump water through water pipes and valves, through the filtered water outlet or through a separate backwashing inlet on the filter housing into said filter housing, and then pump it against the general flow direction of the water through the at least one panel filter. This pumping is done particularly advantageously through all panel filters. Impurities can here either be collected in the filtrate chamber or washed out of the filter housing at the filtrate outlet.

It is preferably possible that the pump operates during backwashing with the maximum possible short-duration capacity, preferably in an intermittent operation with variation between the maximum capacity and halting pump operation. This allows backwashing with an increased water pressure and in a manner of speaking abruptly, which can greatly increase its effectiveness, in particular for detaching objects or particles retained in the panel filter. Advantageously, a maximum possible short-duration capacity of the pump can be at least 30% above a maximum continuous capacity, possibly between 50% and 100%.

In an advantageous embodiment of the invention, the change in the shape and/or arrangement of the panel filter inside the filter housing during the backwashing operation take place only after water has been pumped by the pump against the flow direction through the at least one panel filter or after fresh water has been passed from the outside under pressure through the at least one panel filter. Backwashing has therefore already begun. A time-lag can be at least 2 seconds after, advantageously up to 5 seconds or up to 10 seconds after.

In a development of the invention, it is possible during filter operation with the previously described fine filtering degree for more than 50% of the water passed or pumped by the filter device to be pumped in the flow direction through the coarse panel filter with the coarse filtering degree. A proportion of less than 50%, in particular less than 20%, can be pumped here, additionally or alternatively to the coarse panel filter, through the fine panel filter. The fine filtering of water can take place during a wash program. In filter operation, water that must be filtered overall using the fine panel filter can be pumped several times through the filter device, in particular at least five times or at least ten times. It can be pumped through the fine panel filter in each case in a proportion of less than 50%, in particular less than 20%. Preferably, however, all the water circulating in the domestic appliance is both coarse-filtered and fine-filtered, and particularly preferably several times.

These and further features are found in the description and in the drawings as well as in the claims, wherein the individual features can each be realized singly or severally in the form of sub-combinations in one embodiment of the invention and in other fields, and can represent designs advantageous and protectable per se, for which protection is claimed here. The subdivision of the application into individual sections and sub-headings does not limit the statements made thereunder in their general validity.

### BRIEF DESCRIPTION OF THE DRAWINGS

Further advantages and aspects of the invention can be found in the claims and in the description of examples of the invention that are explained in the following on the basis of the figures. The figures show in

FIG. 1 a highly schematized lateral section through a washing machine in accordance with the invention with a filter in accordance with the invention,

FIG. 2 a schematized lateral section through a filter in accordance with the invention,

FIG. 3 a simplified and variant representation of the filter similar to FIG. 2 with a coarse filter and a fine filter therein,

FIG. 4 a longitudinal section through a filter similar to FIG. 2 with structure of the filter housing,

FIG. 5 a perspective section similar to FIG. 4 through a further variant of the filter with coarse filter and fine filter,

FIG. 6 a straight plan view onto the longitudinal section of FIG. 5,

FIG. 7 a simplified sectional representation similar to FIG. 2 with illustration of the water flow and filtrate flow,

FIG. 8 a section similar to FIG. 6 through the filter from FIG. 7,

FIG. 9 a variation of the filter from FIG. 7 with slightly rotated upper coarse filter,

FIG. 10 a further variation similar to FIG. 9 with compressed upper coarse filter,

FIG. 11 a further variation of the filter from FIG. 9 with markedly rotated upper coarse filter,

FIG. 12 a plan view onto the coarse filter over a planar extent with a surrounding coarse filter frame and coarse filter actuators in the form of bimetallic strips acting thereon,

FIG. 13 a side view of a further possibility for position change of the coarse filter by pivoting it around a central pivot point and

FIG. 14 another further variation similar to FIG. 13 with pivoting of the coarse filter about a pivot point located at its end.

### DETAILED DESCRIPTION OF THE EXAMPLES

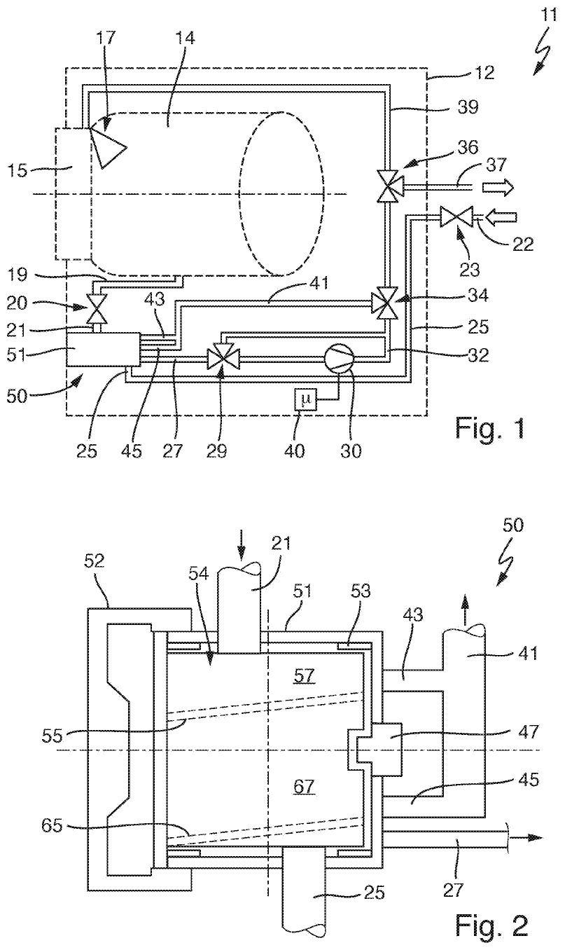

FIG. 1 shows a washing machine 11 as a water-bearing domestic appliance in accordance with the invention with a housing 12. Inside the washing machine 11, a drum 14 with a door 15 for access thereto is provided as is usual. At the top and front of the drum 14 an injection device 17 is provided to supply water in known manner onto the laundry located inside the drum 14.

An drain pipe 19 with a drain valve 20 to allow control of drainage leads out of the drum 14 at the bottom. A waste water inlet 21 to a filter 50 in accordance with the invention is connected to the drain valve 20 as a filter device in accordance with the invention. The filter has a filter housing 51 and numerous other functional details shown in detail in the following in FIGS. 2 to 14.

On the right, a feed 22 with a feed valve 23 leads into the washing machine 11. A feed line 25 leading to the filter 51 is connected thereto. A filtered water outlet 27 which leads to a pump valve 29 designed as a three-way valve leads from the filter 51 to the right. A first way leads to a pump 30 advantageously designed as a heatable pump with integrated heating element. A pipe leads from the pump 30 or from a pump outlet 32 to an outlet valve 34 also designed as a three-way valve. An upper pipe also leads from the pump valve 29 to the inlet of the outlet valve 34, to form in a manner of speaking a bypass past the pump 30.

A pipe leads upwards from the outlet valve 34 to a drain valve 36 also designed as a three-way valve. One way leads rightwards to a an drain outlet 37 from the washing machine 11. A riser pipe 39 leads upwards to the aforementioned injection device 17.

A coarse filtrate outlet 43 and a fine filtrate outlet 45 lead from the filter 50 to a filtrate pipe 41 which also leads to the outlet valve 34. Finally, a control unit 40 for the entire washing machine 11 or for all functional modules, in particular the aforementioned functional modules, is provided therein.

As can be seen from the representation of the various valves and pipes, water exiting the drum 14 can flow along the drain pipe 19 through the filter 50 and be filtered both coarsely and finely, i.e. twice. The water well-filtered as a result exits the filter 50 at the filtered water outlet 27 and can be pumped by the pump valve 29 and the pump 30 for example back to the injection device 17, possibly being heated if hot water is needed. It can also be pumped out at the drain outlet 37. Fresh water can be supplied by means of the feed valve 23 at the feed 22 and enters the filter 50 via the feed line 25 to a backwashing inlet, not shown her, in order to backwash the filter with the water pressure of the fresh water alone. Filtrate washed out during backwashing is washed out via the filtrate pipe 41 and the outlet valve 34 and drain valve 36 at the drain outlet 37. Alternatively, it could also be collected and disposed of separately.

It is also possible for water from the feed 22, i.e. fresh water, to be supplied into the water circuit before the filter 50 for a wash cycle. Alternatively, water can pass via the pump valve 29, if the latter is for example designed as a four-way valve, to the pump 30 and hence into the drum 14.

Furthermore, the washing machine 11 has a control unit 40 which is connected to the aforementioned functional units in a manner not shown here and in particular controls them. Advantageously, this control unit 40 is the only control unit for the entire washing machine 11. It can initiate backwashing in an automated or independent manner. Alternatively, this can be selectively initiated by an operator.

FIG. 2 shows the filter 50 in accordance with the invention in a side view as a schematized side view. The filter 50 has the filter housing 51 as an outer housing, inside which an inner housing 53 is located. Advantageously, this has a corresponding shape and is only slightly smaller than the filter housing 51. The inner housing 53 is rotatable relative to the filter housing 51 by a narrow angle of for example up to 45° or up to 30° about the rotation axis shown in a dashed line. A rotary drive 47 for this rotation, for example a stepping motor, if applicable with a clutch, is shown schematized. If the filter housing 51 is arranged rigid and immobile inside the washing machine 11, the inner housing 53 can be rotated about the rotation axis by means of the rotary drive 47, such that the filters arranged therein take up a different position. By changing the gravity acting on them, a change in the filtering degree of these filters can be achieved.

The filter housing 51 is closed from the left by means of a cover 52, which is for example screwable, permitting the removal of coarse objects such as buttons etc. Inside the filter housing 51, a filter chamber 54 is provided which in a manner of speaking refers to the entire interior with filters. In this filter chamber 54, a coarse filter 55 as a panel filter in accordance with the invention is arranged in the upper area and extending obliquely from top right to bottom left. A fine filter 65, likewise designed as a panel filter, is arranged with a similar inclined position a short distance beneath it. The coarse filter 55 and the fine filter 65 are mounted on the inner housing 53. A coarse filtrate chamber 57 is formed above the coarse filter 55. A fine filtrate chamber 67 is formed below the latter and above the fine filter 65. Coarse filtrate and fine filtrate retained by the appropriate filters collect in the coarse filtrate chamber 57 and in the fine filtrate chamber 67. The water entering from above at the waste water inlet 21 therefore passes first through the coarse filter 55 and then the fine filter 65. It can then exit bottom right at the filtered water outlet 27 and for example be pumped further by the pump 30 via the pump valve 29 in accordance with FIG. 1. This water is thus filtered twice, once coarsely and once finely. It is prevented in this way that the pump 30 can be damaged by oversized objects in the water, for example coarse objects or coarse dirt. Furthermore, the filtered-out parts cannot collect or accumulate inside the pump 30. It is also possible to filter out disruptive objects such as microfibers by using an appropriate fine filter 65, such that they can be removed from the entire water circuit.

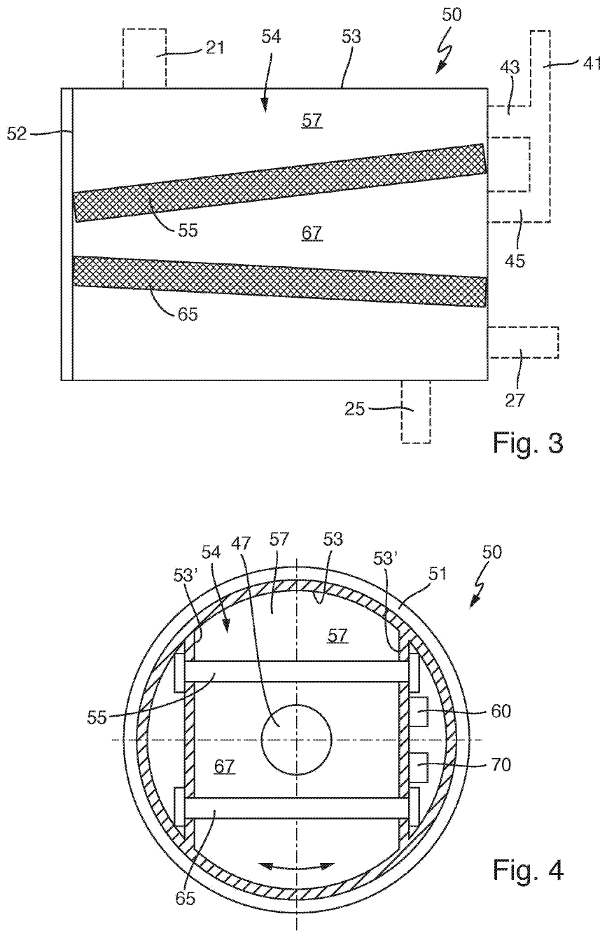

It can be discerned from the further simplified lateral sectional representation in FIG. 3 how an inclined position of one of the filters 55 or 65 can also vary. The upper coarse filter 55 has a similar inclined position as in FIG. 2. The fine filter 65 arranged thereunder is by contrast slightly inclined from top left to bottom right. This may result in easier backwashing of the filter 50, in which water, in particular fresh water, flows by means of the feed line 25 from the bottom into the filter 50 or into the inner housing 53. In the fine filtrate chamber 67, filtered-out fine filtrate is present on the fine filter 65, i.e. lies on top of the fine filter 65 and is spread out there. This fine filtrate is washed out during backwashing to a fine filtrate outlet 45 and into the filtrate pipe 41, for removal or disposal as described above. Furthermore, the water introduced flows upwards out of the feed line 25, also from the bottom, through the coarse filter 55. In this way, the water can also carry away filtered-out coarse filtrate that has collected on the coarse filter 55 and wash it out at the coarse filtrate outlet 43 into the filtrate pipe 41. Some of the fine filtrate may also be pressed here from the bottom through the coarse filter 55, which is however not disruptive as it can pass through the latter with little problem. In some circumstances, it may also be possible to dispense with the fine filtrate outlet 45 and to wash out all the filtrate above the coarse filter 55 out of the filter housing 51. The use of two filtrate outlets has however proved to be advantageous. They are of course also merged outside the filter 50.

In a further variant, a coarse filtrate outlet could also be provided at the left on the filter housing 51, i.e. on the opposite side, in the case of the inclined position of the coarse filter 55 shown here. The distance for washing out the coarse filtrate that has tended to collect at bottom left would then be shorter.

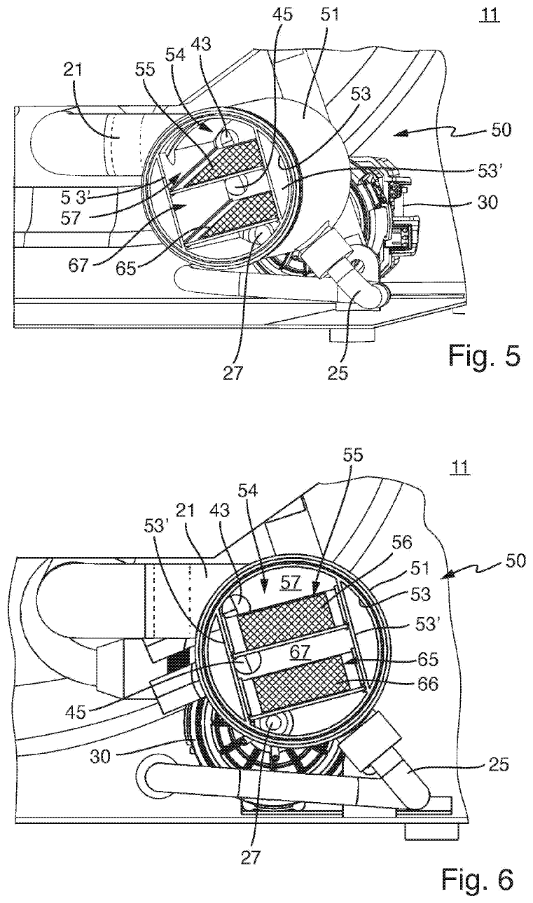

One possibility for changing the position or arrangement the panel filters is shown in FIG. 4 together with FIGS. 5 and 6. In FIG. 4, the rotation axis from FIG. 2 runs vertical to the drawing plane, and the rotary drive 47 is provided behind. It can be discerned that the inner housing 53 is relatively tight inside the filter housing 51 and is advantageously sealed off from the latter at several points. While the inner housing 53 is therefore substantially tubular, it has two parallel inner walls 53′ offset inwards by the same degree on the left and on the right. The coarse filter 55 and the fine filter 65 are fastened at top and at the bottom of these inner walls 53′. In the example shown here, they are rotatably mounted on the inner wall 53′. Short stub axles extend here both from the coarse filter 55 and from the fine filter 65 through the inner walls 53′. The coarse filter 55 and the fine filter 65 can be rotated or pivoted about the stub axles independently of one another about rotation axes extending in the drawing plane and at right angles to the inner walls 53′.

As shown by the arrow at the bottom, the inner housing 53 can be rotated by means of the rotary drive 47 at least by narrow rotation angles. This allows a filter surface of the coarse filter 55 and of the fine filter 65 to be tilted leftwards or rightwards and jointly. This can be done additionally or alternatively to the aforementioned rotation.

For further influencing of the filters, a coarse filter actuator 60 is arranged at the top of the right-hand inner wall 53′ and a fine filter actuator 70 at the bottom. With actuators of this type, it is also possible, as described in the following in more detail, to achieve a direct shape change of the panel filters or of the coarse filter 55 and/or of the fine filter 65 and hence also to directly change their filtering degrees. This may also permit an aforementioned rotation of the filters.

FIG. 5 shows slightly obliquely, and FIG. 6 shows from the front, a section through the filter 50 in accordance with the invention inside the washing machine 11. It can be seen here how the waste water inlet 21 passes water from the left, from the drum of the washing machine water to the filter 50, and how the water enters the filter chamber 54 in general and above all firstly into the coarse filtrate chamber 57. By means of the coarse filter 55 forming its bottom, coarse objects are filtered out of the waste water entering and remain on the top of the coarse filter 55. The water and also fine objects pass through the coarse filter 55 and reach the fine filtrate chamber 67, which is limited at the bottom by the fine filter 65 with its fine filter surface 66. Since the fine filter 65 also retains the fine objects, only water passes through it and can then exit at the filtered water outlet 27 as finely filtered water. It then passed, as shown in FIG. 1, to the pump 30 and is pumped further.

The discernible uniform inclined position of the two filters 55 and 65 has an influence on their filter effect. Furthermore, coarse objects filtered out by the coarse filter 55 and fine objects filtered out by the fine filter 65 tend to slip leftwards as filtrate and are hence closer to the coarse filtrate outlet 43 and to the fine filtrate outlet 45 respectively. In this way, their removal by backwashing using water in the feed line 25 can be simplified.

It is also possible for the inner housing 53 not to be rotated during the filtering process, but appropriately rotated by the control unit 40 using the rotary drive 47 only for a backwashing process.

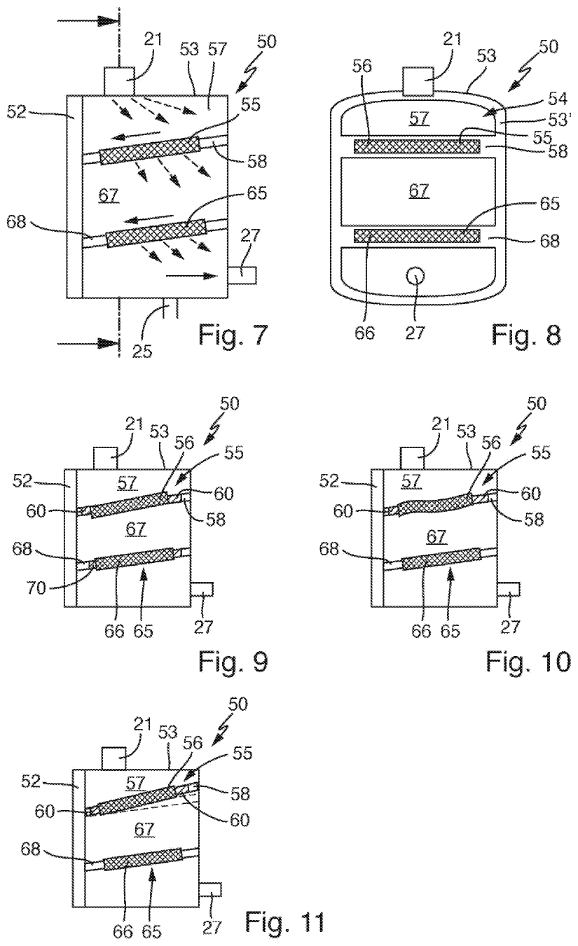

FIG. 7 shows the water flow and the movement of filtrate in a greatly simplified side view similar to FIG. 3. At the waste water inlet 21, waste water shown in dashed lines enters the inner housing 53 or the filter chamber 54. It contacts the upper coarse filter 55, which retains coarse objects but lets water and fine objects pass through downwards. As a result, coarse objects slip leftwards and collect in the area towards the cover 52 as shown by the solid arrow. As indicated by the further dashed-line arrows, water with fine objects passes as dirt downwards through the coarse filter 55 and into the fine filtrate chamber 67 underneath. This water contaminated with fine objects there contacts the fine filter 65, which also retains the fine objects. The double-filtered water then passes downwards through the fine filter 65 and exits the filter 50 at the filtered water outlet 27. Fine objects too collect leftwards towards the cover 52 along the fine filter surface 66 of the fine filter 65, as indicated by the solid arrow. Due to the aforementioned possibilities for influencing the coarse filter 55 and/or the fine filter 65, their filtering degrees can be changed during filtering, for example because the washing machine 11 has detected by its control unit 40 that finer filtering is needed or coarser filtering is possible. The filtering degree can also be changed for example after detection of a certain fiber type, preferably microfibers. It can preferably be attempted to filter microfibers from laundry to be washed more thoroughly in order to remove them from the water circuit. This enables the filtering degree to be changed at least within certain limits before filtering or while filtering water during a wash cycle.

FIG. 8 shows, in a representation similar to FIG. 4 from the front in section, how the coarse filter 55 with coarse filter surface 56 and the fine filter 65 with fine filter surface 66 extend or are arranged parallel to one another. Also to be seen here is a coarse filter frame 58 framing the coarse filter 55 or surrounding it once and hence holding it too. A fine filter frame 68 is provided in corresponding form around the fine filter 65. The filter frames 58 and 68 can be used not only to hold and clamp the respective filter surfaces 65 and 66; they can also be used, if applicable together with the aforementioned coarse filter actuator 60 and fine filter actuator 70, to influence the shape of the respective filter surface. To do so, the filter frames 58 and 68 can consist of material which can change its shape due to external influences, for example as a so-called shape-memory alloy under the influence of heat.

It can therefore be seen for example from FIG. 9, which is similar in principle to FIG. 7, that the coarse filter 55 there is rotated slightly counterclockwise to its normal position shown as a dashed line. To do so, its coarse filter surface 56 is clamped in coarse filter actuators 60 as a filter frame or is held by the latter. This admittedly minor rotation is achieved by influencing the coarse filter actuators 60. For the fine filter 65, it can be discerned that there too fine filter actuators 70 are provided. These are however not used for a shape change and/or position change of the fine filter 65.

In the further representation of FIG. 10, it can be discerned that in the coarse filter 50 the coarse filter actuators 60 have caused a compression as a shape change. The coarse filter 55 or its coarse filter surface 56 in between have been somewhat shortened, so that it is slightly wavy as can be seen. As a result of this the filter effect or the filtering degree too of the coarse filter 55 or of its coarse filter surface 56 are changed, in particular the filtering degree is increased or individual filter meshes become smaller. Such a change can generally be made either to filter waste water or for backwashing. As a rule, a compression of the filter surface will cause a narrowing of its filter meshes and hence an increase in the filtering degree, so that ever smaller objects are retained. This shape of the coarse filter 50 or of the coarse filter surface 56 can thus be used for normal filtering of waste water. For backwashing in particular it may be an advantage when the filtering degree is in a manner of speaking reduced or the filter meshes become larger, such that coarse objects or filtrate trapped therein can be more easily detached and removed during backwashing. To do so, a filter surface should of course be designed accordingly, advantageously as a wire strainer or the like.

For the fine filter 65, no influencing is shown, but this can be achieved advantageously in the same manner as for the coarse filter 55, even if the filtering degree per se is different. It is in fact considerably higher for fine filtering.

FIG. 11 shows, based on FIG. 9, how the coarse filter 55 with the coarse filter surface 56 is lifted in the right-hand area by the coarse filter actuators 60 out of the position shown by dashed lines. As a result, the inclined position of the coarse filter 55 is changed, so that the filtering degree can be changed above all during filtering of waste water from the waste water inlet 21 and less so during backwashing. Examples of this are shown below in FIGS. 13 and 14 and explained there. The more inclined a filter surface is arranged, in this case the coarse filter surface 56, the fewer objects pass downwards through it and are in a manner of speaking filtered out. In FIG. 11 too, no influencing possibility and no change in the filtering degree or in the arrangement is shown for the fine filter 65 or its fine filter surface 66.

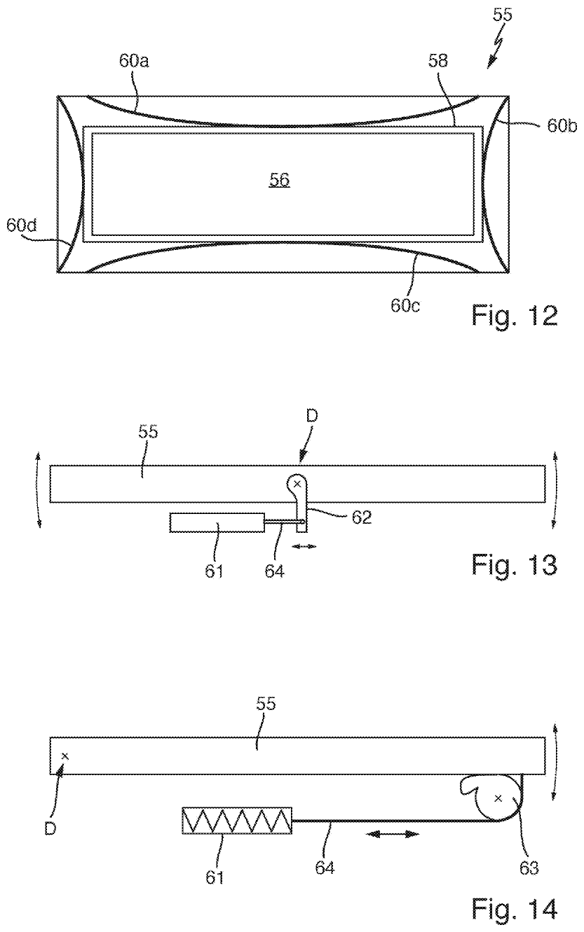

FIG. 12 shows a plan view onto the coarse filter 55 with its coarse filter surface 56. An arrangement for the fine filter together with the fine filter surface 66 can also be provided in similar form. A coarse filter frame 58 to which the coarse filter surface 56 is fastened, for example as a strainer or wire mesh, has a rectangular shape and is held on the outside by four arc-shaped or curved coarse filter actuators 60a to 60d. These filter actuators 60a to 60d are designed here as bimetallic strips. These coarse filter actuators 60 as bimetallic strips can be designed such that they reduce their curvature at increasing temperature in the range between 15° C. and 60° C. or even up to 90° C., and hence pull them outwards in those areas in which they are fastened to the coarse filter frame 58, away from the central area. For example, the opposite coarse filter actuators 60a and 60c or 60b and 60d would pull out the coarse filter surface 56 and thus stretch it. This would widen or enlarge a mesh width and reduce the filtering degree accordingly, which would be good above all for backwashing. Alternatively, the actuators can be designed exactly the other way round, i.e. expand the coarse filter surface 56 in this direction at decreasing temperatures and compress it more at increasing temperatures, which would lead to a reduction in the size of the filter meshes and hence to an increase in the filtering degree. This can be used for example to permit better backwashing by changing the filtering degree for backwashing with fresh water from the feed 22, that is as a rule rather cold.

The coarse filter actuators 60 in the form of bimetallic strips can thus be changed by a temperature of the water flowing into the filter 50, whatever the direction from which this water might come. Alternatively, heaters for the bimetallic coarse filter actuators 60 could of course be provided that can be controlled separately by the control unit 40 for selective control regardless of a water temperature.

In a comparison with FIG. 4, it can be discerned that the coarse filter actuators 60 can also be arranged outside the inner walls 53′ or outside the filter chamber 54 or the coarse filtrate chamber 57 and the fine filtrate chamber 67. The design and the control could then be simplified.

Instead of coarse filter actuators 60 pressing on a coarse filter frame 58 or on a fine filter frame, the filter frames themselves could also consist of a shape-memory alloy or of a bimetallic material. They can therefore change their shape directly and hence influence directly the respective, i.e. increase or reduce the filtering degree. It is in particular the use of shape-memory alloys instead of bimetals that permit more complex shape changes, for example waviness of a filter in the side view, similarly to what is shown in FIG. 10. This is then achieved not by pressing or compression, but forms in a manner of speaking by itself. A filter surface itself can also generally consist of a shape-memory alloy. It can therefore directly shape itself, it can for example be wavy, flat or planar. It can therefore itself change, increase or reduce its filtering degree in the manner mentioned above.

FIG. 13 shows a another further possibility for how an arrangement of a filter can be influenced. The coarse filter 55 is, as may also be the case for the fine filter 65, rotatably mounted, with a rotation axis passing through the center vertically to the drawing plane and corresponding to a pivot point D, on the inner housing 53 or on the inner walls 53′. In this area, a coupling lever 62 is fastened to the coarse filter 55, advantageously to its filter frame. A coarse filter drive 61 acts by means of a transmission member 64 on the coupling lever 62 such that the coupling lever 62 and hence also the coarse filter 65 are rotated clockwise or counterclockwise about the pivot point D. The coarse filter drive 61 can be designed here as an electromagnet, a hydraulic or pneumatic cylinder, a linear motor or even as a bimetal or as a shape-memory alloy. In any event, it should be precisely controllable to permit precise setting of a rotation of the coarse filter 55 and hence a change in the angle of its filter surface 56 to the horizontal. Alternatively, two stops can be provided which in a manner of speaking create two end positions and hence precisely two different positions of the filter surface 56 to the horizontal.

FIG. 14 shows an alternative for an adjustment of the coarse filter 55. The latter has a pivot point D with a corresponding rotation axis at far left about which it is rotatable or pivotable. A further coarse filter drive 61 is provided which is connected to the right-hand end of the coarse filter 55 by means of a transmission member 64 which passes around a deflection 63. A rotation of the coarse filter about the pivot point D arranged at the left-hand end takes place to match a deflection by the coarse filter drive 61. The latter is shown here as a helical spring that consists of a shape-memory alloy. If it is heated up to a relatively high temperature of 40° C. or more, it expands, and the transmission member 64 moves rightwards and thus pivots the coarse filter 55 counterclockwise about the pivot point D. If the coarse filter drive 61 is cooled or set to a temperature of for example less than 20° C., for example by fresh water entering the washing machine 11, it contracts. Such a shortening can be achieved particularly well due to the helical spring shape of the shape-memory alloy material. The transmission member 64 thus moves leftwards again and rotates the coarse filter 65 clockwise about the pivot point D, possibly until it contacts the deflection 63.

1. A filter device for a water-bearing domestic appliance, wherein said filter device has:
a flow-through filter housing with a waste water inlet, a filtered water outlet and a filtrate outlet,
at least one panel filter and a mounting for said panel filter in said filter housing, wherein said panel filter has a mesh width and an angle to the horizontal,
a filtrate chamber in said filter housing for collecting filtrate retained by said panel filter,
wherein
said panel filter, said waste water inlet and said filtered water outlet are arranged relative to one another such that a flow direction for water from said waste water inlet to said filtered water outlet passes through said panel filter,
said filtrate chamber is accessible via said filtrate outlet for removing said filtrate from said filtrate chamber,
said at least one panel filter is variable in shape to change its mesh width, and/or
said angle of said at least one panel filter to said horizontal can be altered by movement of said panel filter.

2. Filter device according to claim 1, wherein said filtrate outlet leads directly to said filtrate chamber, wherein said filtrate outlet is closeable and openable by means of a chamber closure on said filter housing.

3. Filter device according to claim 1, wherein said at least one panel filter has a flat form.

4. Filter device according to claim 1, wherein said filter device has at least two panel filters with a different filtering degree for filtering, wherein said at least two panel filters are arranged one behind the other in said filter housing in said flow direction of said water.

5. Filter device according to claim 4, wherein said two panel filters are arranged one above the other, wherein a first panel filter is arranged above a second panel filter, wherein said waste water inlet is arranged in front of or above an upper first panel filter in said flow direction and said filtered water outlet is arranged behind or below a lower second panel filter in said flow direction.

6. Filter device according to claim 4, wherein a coarse panel filter is provided for a coarse filtering degree and a fine panel filter for a fine filtering degree, wherein an upper first panel filter forms said coarse filter, and wherein a lower second panel filter forms said fine filter.

7. Filter device according to claim 1, wherein said at least one panel filter is positioned inclined at an angle of between 0° and 30° to the horizontal, wherein a downward-facing or downward-inclined outer rim of said panel filter faces said filtrate chamber.

8. Filter device according to claim 4, wherein a first panel filter is arranged underneath said waste water inlet and is positioned inclined at an angle between 0° and 30° to the horizontal, wherein said flow direction passes through said first panel filter directly to said filtered water outlet, wherein a lower outer rim of said first panel filter ends above said filtrate chamber, wherein a second panel filter is arranged in said filtrate chamber being arranged between said filtrate chamber and said filtered water outlet such that filtered water passing through said second panel filter is filtered with its filtering degree, wherein said first panel filter is a coarse filter having a coarse filtering degree and said second panel filter is a fine filter having a fine filtering degree, and wherein an upper first panel filter forms said coarse filter, and wherein a lower second panel filter forms said fine filter.

9. Filter device according to claim 1, wherein an actuator device is arranged on said panel filter and is designed to change its shape such as bend, rotate or compress said panel filter one or more times, wherein said panel filter has filter meshes that are altered by said shape change, and whose mesh width is changed in such a way that impurities sticking to said panel filter are detachable during backwashing of said panel filter against said flow direction of said water.

10. Filter device according to claim 9, wherein said actuator device is designed bimetallic, as a shape-memory alloy, variable in shape by changing a pH value in its environment, or is operating electromotively, electromagnetically or electrothermically.

11. Filter device according to claim 1, wherein said panel filter has an auxetic structure, wherein said panel filter has filter meshes are alterable in their size or mesh width thanks to said auxetic structure, and whose mesh width is changed in such a way that impurities sticking to said panel filter are detachable during backwashing of said panel filter against said flow direction of said water.

12. Filter device according to claim 1, wherein part of a frame of said panel filter or a mounting for said panel filter consists of a shape-memory alloy or has an actuator device consisting of a shape-memory alloy, wherein a shape change of said shape-memory alloy is temperature-dependent and wherein a trigger temperature for said shape change is between 40° C. and 80° C.

13. Filter device according to claim 1, (a) wherein (i) an actuator device is arranged on said panel filter and is designed to change its shape such as bend, rotate or compress said panel filter one or more times, wherein said panel filter has filter meshes that are altered by said shape change, and whose mesh width is changed in such a way that impurities sticking to said panel filter are detachable during backwashing of said panel filter against said flow direction of said water, or (ii) part of a frame of said panel filter or a mounting for said panel filter consists of a shape-memory alloy or has an actuator device consisting of a shape-memory alloy, wherein a shape change of said shape-memory alloy is temperature-dependent and wherein a trigger temperature for said shape change is between 40° C. and 80° C.; (b) wherein a heater is associated with said at least one panel filter or with said actuator device; and (c) wherein said heater is arranged at a distance of less than 2 cm to said panel filter or to said actuator device in said filter housing or said heater is an integral part of a filter surface of said panel filter itself.

14. Filter device according to claim 1, wherein said filter housing or said at least one panel filter is designed rotatable, wherein for a rotary drive is arranged outside said filter housing for said rotatability, wherein said rotary drive is designed to operate electromotively, electromagnetically or electrothermically.

15. Water-bearing domestic appliance with one said filter device according to claim 1, wherein said domestic appliance has:
a treatment chamber for items to be cleaned,
water pipes to said treatment chamber and away from said treatment chamber,
valves in said water pipe,
a pump and a heating unit being interconnected to said water pipes and connected to said treatment chamber and to said filter device,
an appliance control unit.

16. Water-bearing domestic appliance according to claim 15, wherein said filter device is arranged in said flow direction of said water between said treatment chamber and said pump, wherein no functional units are arranged between said treatment chamber and said filter device except for filters/strainers and valves.

17. Method for cleaning a filter device according to claim 1, wherein:
during a filter operation of said filter device, water to be filtered enters or is pumped into said filter device at said waste water inlet, and filtered water exits at said filtered water outlet and is pumped further by means of said pump in said domestic appliance,
during backwashing operation of said filter device or of at least one of said panel filters of said filter device, said shape and/or said arrangement of said panel filter in said filter housing are changed.

18. Method according to claim 17, wherein said shape and/or said arrangement of said panel filter in said filter housing is changeable thermically by heating and/or is mechanically changeable by shaping of said panel filter.

19. Method according to claim 17, wherein during backwashing of said at least one panel filter said pump pumps water through water pipes and valves, through said filtered water outlet or through a separate backwashing inlet on said filter housing into said filter housing and against said flow direction of said water through said at least one panel filter or through all said panel filters, wherein impurities are either collected in said filtrate chamber or are washed out of said filter housing at said filtrate outlet.

20. Method according to claim 19, wherein said pump operates during backwashing with a maximum possible short-duration capacity in an intermittent operation with variation between a maximum possible short-duration capacity and halting pump operation.

21. Method according to claim 17, wherein said change in said shape or arrangement of said panel filter inside said filter housing during said backwashing operation takes place only after water has been pumped by said pump against said flow direction through said at least one panel filter or after fresh water has been passed from said outside under pressure through said at least one panel.

22. Method according to claim 17, (a) wherein (i) a coarse panel filter is provided for a coarse filtering degree and a fine panel filter for a fine filtering degree, wherein an upper first panel filter forms said coarse filter, and wherein a lower second panel filter forms said fine filter, or (ii) an actuator device is arranged on said panel filter and is designed to change its shape such as bend, rotate or compress said panel filter one or more times, wherein said panel filter has filter meshes that are altered by said shape change, and whose mesh width is changed in such a way that impurities sticking to said panel filter are detachable during backwashing of said panel filter against said flow direction of said water; and (b) wherein during said filter operation with said fine filtering degree more than 50% of said water pumped through said filter device is pumped in said flow direction through said coarse panel filter with said coarse filtering degree, wherein a proportion of less than 50% is pumped, additionally or alternatively to said coarse panel filter, through said fine panel filter.

23. Method according to claim 22, wherein said fine filtering of water takes place during a wash program.

24. Method according to claim 22, wherein during said filter operation water that must be filtered overall using said fine panel filter is pumped several times through said filter device, wherein it is pumped through said panel filter in each case in a proportion of less than 50%.

25. Method according to claim 24, wherein during said filter operation water that must be filtered overall using said fine panel filter is pumped at least five times or at least ten times through said filter device.
